(19) United States
(12) Patent Application Publication
(10) Pub. No.: US 2009/0016078 A1
(43) Pub. Date: Jan. 15, 2009

(54) LIGHT VALVE TO ENHANCE DISPLAY BRIGHTNESS

(75) Inventors: Thomas D. Murray, Winchester (GB); Paul D. Crouch, Burnham (GB); Stephen D. Harris, Basingstoke (GB)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/774,840

(22) Filed: Jul. 9, 2007

(51) Int. Cl. F21V 8/00; H01J 9/00

(52) U.S. Cl. 362/615; 445/24

(57) ABSTRACT

A display system (300) that includes a first display (302) and at least a second display (304). A light guide (330) can be positioned between the first display and the second display. Further, a light valve (342) can be positioned between the light guide and the second display. The light valve can be operable between a first state in which the light valve is substantially optically clear and a second state in which the light valve is not substantially optically clear. For example, the light valve can be substantially opaque in the second state. The display system (300) can be integrated into a display device (500). The display device can be a hinged display device.

### BACKGROUND OF THE INVENTION

1. Field of the Invention

The present invention generally relates to electronic devices and, more particularly, to electronic devices having a plurality of displays.

2. Background of the Invention

Clamshell and flip type mobile telephones (hereinafter “hinged telephones”) are popular among consumers. Referring to FIG. 1, an example of a typical hinged telephone 100 is depicted. The hinged telephone 100 typically will include two structural members 102, 104 which are attached to one another via a hinge 106. The structural members 102, 104 can be rotated with respect to one another about the hinge 106 to operate between an open position, shown in FIG. 1, and a closed position, shown in FIG. 2.

The hinged telephone 100 may include a plurality of liquid crystal displays (LCDs). For example, the hinged telephone may include a first display 108, located on a first side 110 of the structural member 102, which can be viewed while the hinged telephone 100 is in the open position, as shown in FIG. 1. The hinged telephone also may include a second display 212, located on a second side 214 of the structural member 102, which can be viewed while the hinged telephone 100 is in the closed position, as shown in FIG. 2.

In order to keep the structural member 102 thin, and thereby minimize the overall dimensions of the hinged telephone 100, a single lamp and a single light guide usually are used to provide backlighting for both the first and second displays 108, 212. Typically, this configuration does not adequately illuminate both of the displays 108, 212. To compensate, preference is usually given to the first display 108, and a semi-reflective coating is applied to one side of the light guide to direct most of the light to the first display 108. Unfortunately, this prevents a sufficient amount of light from being provided to the second display 212, which results in the second display 212 being difficult to view, especially in bright sunlight.

### SUMMARY OF THE INVENTION

The present invention relates to a display system that includes a first display and at least a second display. A light guide can be positioned between the first display and the second display. Further, a light valve can be positioned between the light guide and the second display. The light valve can be operable between a first state in which the light valve is substantially optically clear and a second state in which the light valve is not substantially optically clear. For example, the light valve can be substantially opaque in the second state.

The light valve can include at least one material selected from the group consisting of a polymer dispersal liquid crystal (PDLC) and a polymer network liquid crystal (PNLC). A change in strength of an electric field can operate the light valve between the first state and the second state.

The second display can be configured to have at least a first dimension, and the light valve can be configured to have at least a second dimension that is at least substantially congruent to the first dimension. In one arrangement, the second display and the light valve can be substantially parallel to one another. The first display and the second display also can be substantially parallel to one another.

The present invention also relates to a communication device that includes the display system. In one arrangement, the communication device can be a hinged communication device. For example, the communication device can be a hinged mobile station. The first display can be positioned on a first side of a structural member and the second display is positioned on a second side of the structural member.

The present invention also relates to a method of manufacturing a display. The method can include positioning a light guide between a first display and a second display and positioning a light valve between the light guide and the second display, the light valve being operable between a first state in which the light valve is substantially optically clear and at least a second state in which the light valve is not substantially optically clear. For example, the light valve can be configured to be substantially opaque in the second state. The light valve can be formed from at least one material selected from the group consisting of a polymer dispersal liquid crystal (PDLC) and a polymer network liquid crystal (PNLC). Positioning the light valve between the light guide and the second display can include positioning the light valve in a region in which a strength of an electric field is selectively controlled.

### BRIEF DESCRIPTION OF THE DRAWINGS

Preferred embodiments of the present invention will be described below in more detail, with reference to the accompanying drawings, in which:

FIG. 1 is a perspective view of a hinged telephone of the prior art in an open position;

FIG. 2 is a perspective view of the hinged telephone of FIG. 1 in a closed position;

FIG. 3 is an exploded view of a display system that is useful for understanding the present invention;

FIG. 4 is an enlarged section view of a light valve assembly of FIG. 3, taken along section line 4-4;

FIG. 5 is a perspective view of a hinged display device, which is useful for understanding the present invention, in the open position;

FIG. 6 is a perspective view of a hinged display device, which is useful for understanding the present invention, in the closed position; and

FIG. 7 is a flowchart that is useful for understanding the present invention.

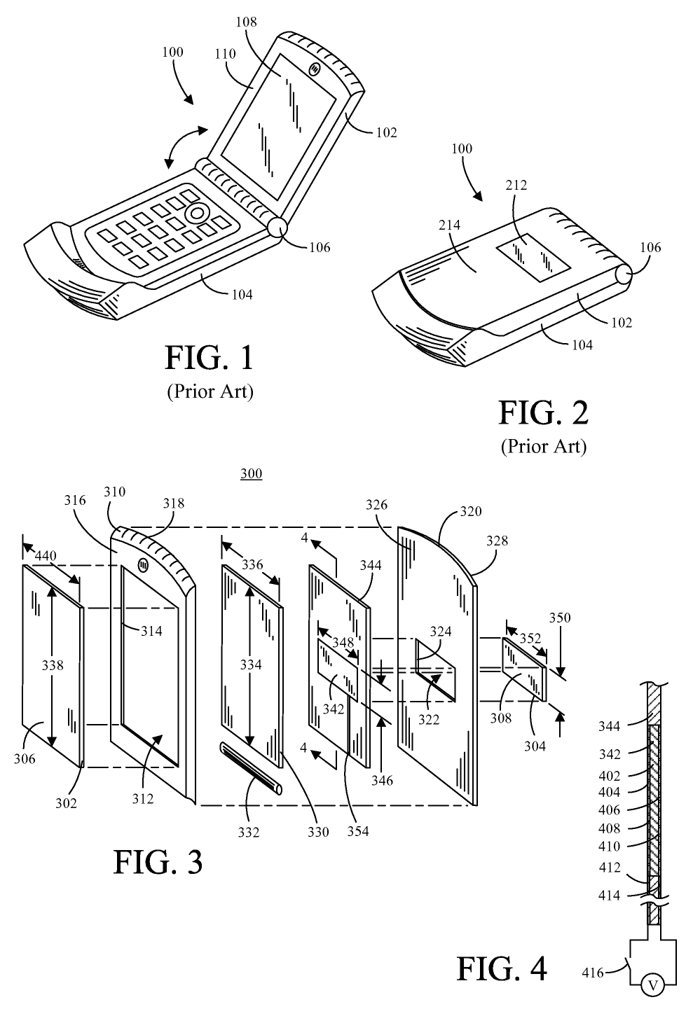

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

FIG. 3 is an exploded view of a display system 300 that is useful for understanding the present invention. In one arrangement, the display device can be a communication device, for example a telephone, a radio, a computer, or a mobile station (e.g. a mobile telephone, a mobile radio, a personal digital assistant, a mobile computer, etc.). In another arrangement, the display device can be a video playback system, such as a television, DVD player, or the like. Still, the invention is not limited in this regard and the display system 300 can be integrated into any other device that includes a plurality of displays that share one or more common light sources, and such devices are within the intended scope of the present invention. A device in which the display system 300 is integrated can be a hinged device, such as a hinged mobile station, but this need not be the case.

The display system 300 can include a first display 302 and a second display 304. The displays can be liquid crystal displays (LCDs) or any other transmissive displays which utilize backlighting. The displays 302, 304 can be configured to have a respective surface 306, 308 that is substantially planar, though this need not be the case. For instance, the surfaces 306, 308 can be concave, convex, or have any other desired shape. The first display 302 and the second display 304 can be substantially parallel to one another or can be non-parallel to one another.

The displays 302, 304 can be attached to one or more structural members. For instance the first display 302 can be attached to a first structural member 310. The first structural member 310 can define a cavity 312 having a perimeter 314 into which the first display 302 can be inserted. In another arrangement, the display 302 can be attached to a front side 316 of the first structural member 310 so as to be positioned in front of the cavity 312, or attached to a back side 318 of the first structural member so as to be positioned behind the cavity 312.

Similarly, the second display 304 can be attached to a second structural member 320. The second structural member 320 can define a cavity 322 having a perimeter 324 into which the second display 304 can be inserted. In another arrangement, the display 304 can be attached to a front side 326 of the second structural member 320 so as to be positioned in front of the cavity 322, or attached to a back side 328 of the first structural member so as to be positioned behind the cavity 322.

In one arrangement, the structural members 310, 320 can be configured to engage one another as components of a combined structural member. In another arrangement, rather than being formed as separate components that engage one another, the structural members 310, 320 can be formed or fabricated as a single structure. In yet another arrangement, the first and second structural members 310, 320 can remain independent of one another, and may even be arranged so as to be moveable with respect to one another.

A light guide 330 can be positioned between the first display 302 and the second display 304. The light guide 330 can be configured to convey light emitted by a lamp 332 to the displays 302, 304. For example, the light guide 330 can comprise an optically clear material, such as glass, plastic, or the like.

In one arrangement, the light guide 330 can have dimensions that are substantially congruent with the dimensions of the first display 302. For example, if the first display 302 and light guide 330 are rectangular, a height 334 and width 336 of the light guide 330 can be substantially similar to the height 338 and width 440 of the first display 302. If the first display 302 and light guide 330 are circular or oval, they can have substantially similar radii. Still, the first display 302 and light guide 330 can be any other shapes and one or more dimensions of such shapes that are congruent. Notwithstanding, in another arrangement the display 302 and light guide 330 also may not have congruent dimensions. For example, the light guide 330 also may be larger or smaller than the first display 302.

A light valve 342 can be positioned between the light guide 330 and the second display 304. The light valve 342 can be substantially parallel to the first display 302 and/or the second display 304. The light valve 342 can comprise a polymer dispersal liquid crystal (PDLC), a polymer network liquid crystal (PNLC) or any other material for which it is possible to selectively vary the intensity of light transmitted through the material. One example of a suitable PDLC is a PDLC film, which can be prepared using Licrilite® Materials for PDLC Applications, available from Merck Specialty Chemicals Ltd. of Southampton, England. Merck Specialty Chemicals Ltd. discloses suitable processes that may be implemented to prepare the PDLC film, for example, polymerisation induced phase separation (PIPS). Such process may be initiated by heat (e.g. an epoxy resin/curing agent) or by UV light (e.g. an acrylate or thiolene system).

For example, a liquid crystal and the pre-polymer may be mixed in a desired ratio by stirring at room temperature until homogeneous, and then filled into a suitable cell, such as an ITO-coated glass with a cell gap of approximately 10-20 mm, by capillary action. Alternatively the liquid crystal/pre-polymer mixture may be coated on to a substrate, such as an ITO-coated glass or plastic, using a suitable technique, for instance bar or doctor blade coating. The mixture then may be cured by exposure to UV light at a wavelength of 350-360 nm. Suitable light sources can include low power fluorescent lamps (e.g. 4-6 mW/cm²) or higher power mercury or metal halide lamps (10-100 mW/cm²). A suitable curing schedule may include a 1-2 minute exposure time with a lamp intensity of 4-14 mW/cm².

In another arrangement, the phase separation process may be controlled by temperature change (TIPS) or solvent evaporation (SIPS). Still, any other suitable processes for preparing the PDLC film may be used and the invention is not limited in this regard.

The light valve 342 can be operable between a first state in which the light valve is substantially optically clear, and one or more other states in which the light valve is not substantially optically clear. For example, in at least one of the other states, the light valve can be substantially opaque. As used herein, the term “substantially optically clear” means that a substantial portion of incident light is transmitted through a material. As used herein, the term “substantially opaque” means that a substantial portion of the incident light is backscattered by the material. A substantial portion of incident light can be greater than 99% of the incident light, greater than 95% of the incident light, greater than 90% of the incident light, greater than 85% of the incident light, greater than 80% of the incident light, greater than 75% of the incident light, greater than 70% of the incident light, greater than 65% of the incident light, greater than 60% of the incident light, greater than 55% of the incident light or greater than 50% of the incident light. As used herein, the term “backscatter” means the deflection and/or radiation of light incident on a first side of an object such that the light is not transmitted through the object so as to radiate from a second opposing side of the object.

In one arrangement, the light valve 342 can be disposed within a valve support member 344. An enlarged section view of such an arrangement, taken along section line 4-4, is shown in FIG. 4. The light valve 342 can comprise optically variable material 402, for which it is possible to selectively vary the intensity of light transmitted through the material as previously described. The light valve 342 also can comprise a plurality of electrodes 404, 406 disposed across opposing surfaces 408, 410 of the optically variable material 402. The electrodes 404, 406 can comprise thin and/or transparent electrical conductors so as not to significantly interfere with the transmission of light through the light valve 342. Such electrodes are known to those skilled in the art of displays.

A voltage (V) can be selectively applied across the electrodes 404, 406, via electrical conductors 412, 414, to establish an electric field in the optically variable material 402, thereby changing its optical characteristics. For example, one or more of the electrical conductors 412, 414 can be electrically coupled to a switch 416 that is selectively opened and closed to selectively change the strength of the electric field in the optically variable material 402. Switches are well known to the skilled artisan, and the switch 416 can be implemented in any suitable manner. In one arrangement the switch 416 can be a variable switch which varies the voltage applied to the electrodes 404, 406. For instance the switch 416 can comprise a variable resistor, a rheostat, or an electronic circuit that outputs a selected voltage.

For example, in an arrangement in which the light valve 342 comprises PDLC or PNLC, when no electric field is applied through the optically variable material 402, or a small electric field is applied, liquid crystal droplets within optically variable material 402 can be randomly oriented. As a result, a substantial portion of light incident on the optically variable material 402 can be backscattered, and thereby be prevented from transmitting through the light valve 342.

When an electric field of sufficient strength is applied through the optically variable material 402, the orientations of the liquid crystal droplets within the optically variable material 402 can become organized. When the liquid crystal droplets are organized, rather than backscattering a substantial portion of incident light, the light valve 342 can transmit the light so as to become substantially optically clear. The strength of the electric field required to suitably organize the orientations of the liquid crystal droplets can be determined by the type and thickness of the optically variable material 402.

For example, if the light valve 342 includes a PDLC film comprising about 80% of Merck Specialty Chemicals' TL liquid crystal in combination with a suitable polymer, such as Merck Specialty Chemicals' PN393, and the thickness of the PDLC film is approximately 10 μm, an electric potential of 6-8 volts can be applied to the electrodes 404, 406 to organize the orientation of the liquid crystals. If a thicker PDLC film is used, higher voltages may be required. Use of other materials and/or mix ratios also may result in a different voltage requirement. Indeed, some PDLC films may require the application of greater than 10 volts, 20 volts, 40 volts, or even 60 volts in order to suitably organize the orientation of the liquid crystals. The applied voltage may be AC or DC.

Referring both to FIG. 3 and to FIG. 4, in one arrangement in which the light valve 342 is a component of a display system 300 that is integrated in a hinged device, the switch 416 can be configured to close when the hinged device is in a closed position, thereby organizing the orientation of the liquid crystal droplets and allowing light to transmit through the light valve 342 to provide light for the second display 304. When the hinged device is opened, the switch 416 can open, thereby allowing the liquid crystal droplets to become randomly oriented, thus backscattering a significant portion of light incident on the light valve 342. The second display 304 thus may appear dark. Much of the backscattered light can be propagated to the first display 302, resulting in the first display 302 receiving a greater amount of light than it would otherwise receive if the light incident on the light valve 342 were not backscattered. The additional light can increase the brightness of the first display 302.

The valve support member 344 can comprise glass, plastic, or any other suitable material. The valve support member 344 can be selected to have opacity substantially similar to the opacity of the light valve 342 when the light valve is in a state in which it is not optically clear. For example, if the light valve transmits only a certain percentage of light when little or no electric field is applied through the light valve, the valve support member 344 can be selected such that it transmits roughly the same percentage of light. Accordingly, the amount of light backscattered by, and transmitted through, the light valve and the valve support member can be uniform when the light valve is not in a state in which it is substantially optically clear.

In such an arrangement, the light valve 342 can be positioned within the valve support member 344 such that the light valve 342 is aligned with the second display 304 when the display system 300 is assembled. Further, the dimensions of the light valve 342 can be substantially congruent to the dimensions of the second display 304. For example, if the light valve 342 and the second display 304 are rectangular, a height 346 and width 348 of the light valve 342 can be substantially similar to the height 350 and width 352 of the second display 304. If the second display 304 and light valve 342 are circular or oval, they can have substantially similar radii. Still, the second display 304 and light valve 342 can be any other shapes and one or more dimensions of such shapes that are congruent.

In another arrangement the light valve 342 may have dimensions that are not congruent to the second display 304. For example, rather than having the light valve 342 positioned within a valve support member 344, the light valve 342 can have dimensions that are substantially similar to the dimensions of the light guide 330 and/or the first display 302.

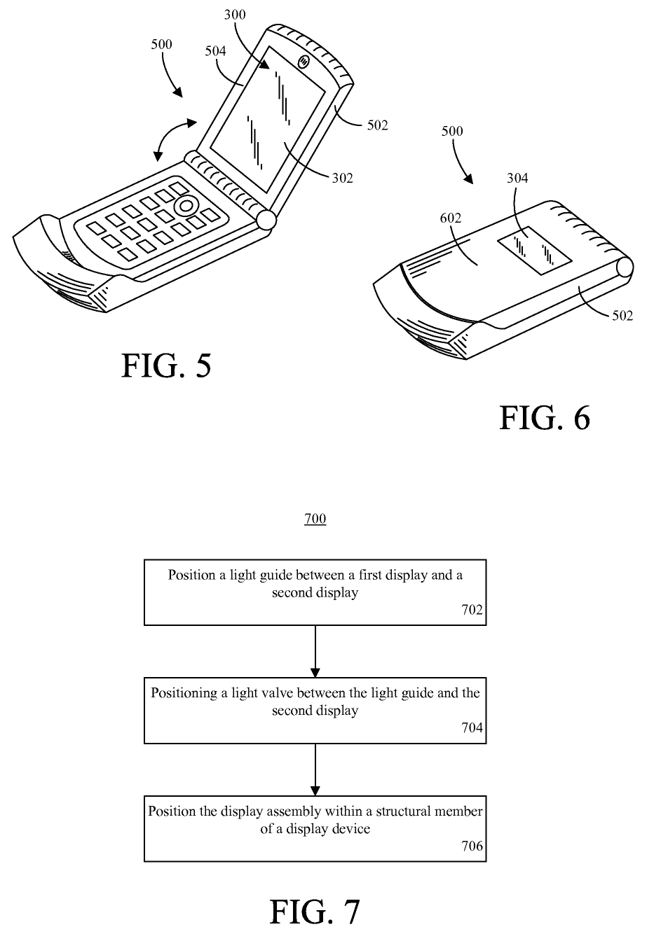

FIG. 5 is a perspective view of a hinged display device 500, which is useful for understanding the present invention, in the open position. The display device 500 can include the display system 300. In one arrangement, the display device 500 can be a hinged display device, for instance a hinged mobile station. The display system 300 can be integrated into a structural member 502 of the display device 500. For example, the first display 302 of the display system 300 can be located on a first side 504 of the structural member 502. Referring to FIG. 6, which depicts the display device 500 in the closed position, the second display 304 can be located on a second side 602 of the structural member 502. As noted, the light guide (not shown) can be positioned between the first display 302 and the second display 304. Further, the light valve (not shown) can be positioned between the light guide and the second display 304.

FIG. 7 is a flowchart presenting a method 700 of manufacturing a display that is useful for understanding the present invention. At step 702, a light guide can be positioned between a first display and a second display. At step 704 a light valve can be positioned between the light guide and the second display. The light valve can be positioned in a region in which a strength of an electric field is selectively controlled. Accordingly, the light valve can be operable between a first state in which the light valve is substantially optically clear and at least a second state in which the light valve is not substantially optically clear. For example, the light valve can be configured to be substantially clear in the first state and substantially opaque in the second state. Proceeding to step 706, the display assembly can be positioned within a structural member of a display device.

The flowchart and block diagrams in the figures illustrate the architecture, functionality, and operation of possible implementations of systems and methods according to various embodiments of the present invention. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

This invention can be embodied in other forms without departing from the spirit or essential attributes thereof. Accordingly, reference should be made to the following claims, rather than to the foregoing specification, as indicating the scope of the invention.

What is claimed is:

1. A display system, comprising:
a first display;
at least a second display;
a light guide positioned between the first display and the second display; and
a light valve positioned between the light guide and the second display, the light valve operable between a first state in which the light valve is substantially optically clear and a second state in which the light valve is not substantially optically clear.

2. The display system of claim 1, wherein the light valve is substantially opaque in the second state.

3. The display system of claim 1, wherein the light valve comprises at least one material selected from the group consisting of a polymer dispersal liquid crystal (PDLC) and a polymer network liquid crystal (PNLC).

4. The display system of claim 1, wherein a change in a strength of an electric field operates the light valve between the first state and the second state.

5. The display system of claim 1, wherein:
the second display is configured to have at least a first dimension; and
the light valve is configured to have at least a second dimension that is at least substantially congruent to the first dimension.

6. The display system of claim 1, wherein the second display and the light valve are substantially parallel to one another.

7. The display system of claim 1, wherein the first display and the second display are substantially parallel to one another.

8. A communication device, comprising:
a display system comprising:
a first display;
at least a second display;
a light guide positioned between the first display and the second display; and
a light valve positioned between the light guide and the second display, the light valve operable between a first state in which the light valve is substantially optically clear and a second state in which the light valve is not substantially optically clear.

9. The communication device of claim 8, wherein the light valve is substantially opaque in the second state.

10. The communication device of claim 8, wherein the light valve comprises at least one material selected from the group consisting of a polymer dispersal liquid crystal (PDLC) and a polymer network liquid crystal (PNLC).

11. The communication device of claim 8, wherein a change in strength of an electric field operates the light valve between the first state and the second state.

12. The communication device of claim 8, wherein:
the second display is configured to have at least a first dimension; and
the light valve is configured to have at least a second dimension that is at least substantially congruent to the first dimension.

13. The communication device of claim 8, wherein the second display and the light valve are substantially parallel to one another.

14. The communication device of claim 8, wherein the communication device is a hinged communication device.

15. The communication device of claim 8, wherein the communication device is a hinged mobile station.

16. The communication device of claim 8, wherein:
the first display is positioned on a first side of a structural member; and
the second display is positioned on a second side of the structural member.

17. A method of manufacturing a display, comprising:
positioning a light guide between a first display and a second display; and
positioning a light valve between the light guide and the second display, the light valve operable between a first state in which the light valve is substantially optically clear and at least a second state in which the light valve is not substantially optically clear.

18. The method of claim 17, further comprising configuring the light valve to be substantially opaque in the second state.

19. The method of claim 17, further comprising forming the light valve from at least one material selected from the group consisting of a polymer dispersal liquid crystal (PDLC) and a polymer network liquid crystal (PNLC).

20. The method of claim 17, wherein positioning the light valve between the light guide and the second display comprises positioning the light valve in a region in which a strength of an electric field is selectively controlled.
